(19) United States
(12) Patent Application Publication
(10) Pub. No.: US 2010/0028682 A1
(43) Pub. Date: Feb. 4, 2010

(54) OPTICAL FUNCTIONAL FILM

(76) Inventor: Seiji Shinohara, Tokyo-to (JP)

Correspondence Address: LADAS & PARRY LLP, 224 SOUTH MICHIGAN AVENUE, SUITE 1600, CHICAGO, IL, 60604, US

(21) Appl. No.: 12/443,018

(22) PCT Filed: Sep. 27, 2007
(86) PCT No.: PCT/JP2007/068812

§ 371 Date: Mar. 26, 2009

(30) Foreign Application Priority Data
Sep. 29, 2006 (JP) 2006-269993

(51) Int. Cl. G02B 1/10; B32B 7/02; B32B 9/00

(52) U.S. Cl. 428/409

(57) ABSTRACT

An optical functional film having an antifouling layer, at an outermost surface, which simultaneously satisfies the anti-fingerprint property, the anti-magic marker property, slippability and water repellency. The optical functional film has: a substrate, an optical functional layer formed on the substrate, and an antifouling layer formed on the optical functional layer and having a ratio Si/C between a silicon element (Si) and a carbon element (C) of 0.25 to 1.0, a ratio F/C between a fluorine element (F) and a carbon element (C) of 0.10 to 1.0 at a surface, and the following characteristics: a. a contact angle of a liquid paraffin is not less than 65° and a falling angle of the liquid paraffin is not more than 15°; b. a contact angle of a black magic marker is not less than 35° and a falling angle of the black magic marker is not more than 15°; and c. a dynamic friction coefficient is less than 0.15.

### TECHNICAL FIELD

The present invention relates to an optical functional film, which is favorably used as an outermost surface layer of a display such as a liquid crystal display device or the like and has an antifouling layer being excellent in anti-fingerprint property, anti-magic maker property and slippability at an outermost surface.

### BACKGROUND ART

Since displayed letters, figures and other information are read in displays such as televisions, personal computers, and cell phones, curved mirrors, back mirrors, goggles, window glasses and other commercial displays, they need various functions such as antireflective property and antidazzle property for preventing reflection of light at surfaces, electroconductivity for shielding electromagnetic waves, barrier property for preventing rusting, etc., light diffraction property as in hologram for enhancing designs and security and/or hard coat property for preventing scratches with external forces. Therefore, optical functional films having these functions are generally provided on the surfaces of such displays.

However, since the optical functional film is disposed on the outermost surface of the display or the like owing to its usage, a fingerprint is attached by direct contact with a human hand and dirt is attached with wind, rain, etc. Attachment of such dirt may hinder readout of the information such as letters, and figures displayed in the display or the like. Accordingly, an antifouling layer is usually formed on the outermost surface of the optical functional film to prevent the attachment of the dirt.

Demanded characteristics required for such an antifouling layer include such as: the anti-fingerprint property against the fingerprint as a fat and oil component to be attached through the contact with the human hand, water repellency against rain water, slippability for wipability of dirt, and anti-magic maker property against graffiti with use of a magic marker. Heretofore, silane-based compounds and fluorine-based compounds have been used for the antifouling layers requiring such various performances.

However, though the silane-based compounds have good anti-magic maker property, slippability and water repellency, they have a problem with a poor anti-fingerprint property. On the other hand, though the fluorine-based compounds have good anti-fingerprint property and water repellency, they have a problem with a poor anti-magic maker property. Under the circumstances, trials have been made to combine the merits of both the compound by mixing or copolymerizing such a silane-based compound and a fluorine-based compound (Patent Document 1, Patent Document 2), but one simultaneously having the merits of both of them and satisfying the anti-fingerprint property, the anti-magic maker property, slippage resistance and water repellency has not been obtained.

Patent Document 1: Japanese Examined Patent Publication 6-29332

Patent Document 2: Japanese Patent Application Publication Laid-open No. 7-16940

### DISCLOSURE OF THE INVENTION

### Problems to be Solved by the Invention

The present invention has been made in view of the above-mentioned problems, and is mainly aimed at providing an optical functional film having an antifouling layer, at an outermost surface, which simultaneously satisfies the anti-fingerprint property, the anti-magic maker property, slippability and water repellency.

### Means for Solving the Problems

To solve the above-mentioned problems, the present invention provides an optical functional film which comprises: a substrate, an optical functional layer formed on the substrate, and an antifouling layer formed on the optical functional layer and having a ratio Si/C between a silicon element (Si) and a carbon element (C) of 0.25 to 1.0, a ratio F/C between a fluorine element (F) and a carbon element (C) of 0.10 to 1.0 at a surface, and the following characteristics: a. a contact angle of a liquid paraffin is not less than 65° and a falling angle of the liquid paraffin is not more than 15°; b. a contact angle of a black magic marker is not less than 35° and a falling angle of the black magic marker is not more than 15°; and c. a dynamic friction coefficient is less than 0.15.

According to the present invention, the above antifouling layer has: an excellent anti-fingerprint property due to the liquid paraffin contact angle of not less than 65° and the liquid paraffin falling angle of not more than 15°; an excellent anti-magic maker property due to the black magic marker contact angle of not less than 35° and the black magic marker falling angle of not more than 15°; and excellent slippability due to the dynamic friction coefficient of less than 0.15. Thus, the antifouling layer can simultaneously satisfy the anti-fingerprint property, the anti-magic maker property and slippability.

In the above invention, the water contact angle of the antifouling layer is preferably not less than 100°. Thereby, it can make the water repellency excellent.

In the above invention, the surface roughness (Ra) of the antifouling layer is preferably not more than 2 nm, when measured by using an atomic force microscope. When the above antifouling layer has excellent smoothness, the antifouling layer is excellent in abrasion resistance and anti-wear property, and can suppress the attachment of the dirt.

In the above invention, the antifouling layer preferably contains a silicon-containing compound having a siloxane group and a fluorine-containing compound containing at least either a perfluoroalkyl group or a perfluoroalkyl ether group. Since both the compounds generally have low surface tensions and tend to exist at a surface, and they are likely to bleed at the surface, even when mixed with other component, an abundance ratio is easily adjusted.

### EFFECTS OF THE INVENTION

The present invention exhibits an effect of providing the optical functional film having the antifouling layer, at the outermost surface, which simultaneously satisfies the anti-fingerprint property, the anti-magic maker property and the slippability.

### BRIEF DESCRIPTION OF THE DRAWING

FIG. 1 is a schematically sectional view of one embodiment of the optical functional film of the present invention.

### EXPLANATION OF REFERENCE NUMERALS

1—Substrate
2—Optical functional layer
3—Antifouling layer

### BEST MODE FOR CARRYING OUT THE INVENTION

The present invention relates to the optical functional film. In the following, the optical functional film of the present invention will be explained.

The optical functional film of the present invention comprises: a substrate, an optical functional layer formed on the substrate, and an antifouling layer formed on the optical functional layer and having a ratio Si/C between a silicon element (Si) and a carbon element (C) of 0.25 to 1.0, a ratio F/C between a fluorine element (F) and a carbon element (C) of 0.10 to 1.0 at a surface, and the following characteristics: a. a contact angle of a liquid paraffin is not less than 65° and a falling angle of the liquid paraffin is not more than 15°; b. a contact angle of a black magic marker is not less than 35° and a falling angle of the black magic marker is not more than 15°; and c. a dynamic friction coefficient is less than 0.15.

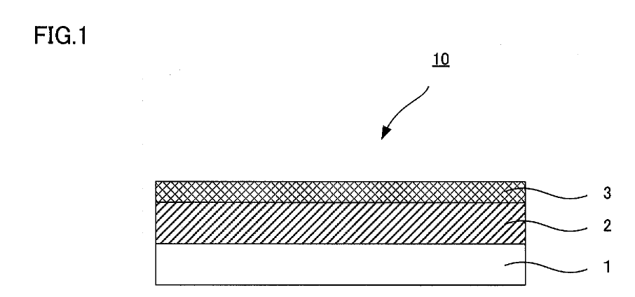

First, the optical functional film of the present invention will be explained with reference to the drawing. FIG. 1 is a schematically sectional view of one embodiment of the optical functional film of the present invention. As shown in FIG. 1, the optical functional film 10 of the present invention comprises a substrate 1, an optical functional layer 2 formed on the substrate 1, and an antifouling layer 3 formed on the optical functional layer 2.

For the antifouling layer formed in the outermost surface layer of the conventional optical functional layer, the silane-based compound and the fluorine-based compound have been used. Though the silane-based compound has good anti-magic maker property, slippability and water repellency, it had a problem with a poor anti-fingerprint property. On the other hand, though the fluorine-based compound has good anti-fingerprint property and water repellency, it had a problem with a poor anti-magic maker property. Under these circumstances, trials have been made to combine the merits of both the compound by mixing or copolymerizing such a silane-based compound and a fluorine-based compounds, but one simultaneously having the merits of both of them and satisfying the anti-fingerprint property, the anti-magic maker property, slippage resistance and water repellency has not been obtained.

With respect to this, according to the present invention, the antifouling layer has: excellent anti-fingerprint property due to the characteristics that the liquid paraffin contact angle is not less than 65° and the liquid paraffin falling angle is not more than 15°; excellent anti-magic maker property due to the black magic marker contact angle of not less than 35° and the black magic marker falling angle of not more than 15°; and excellent slippability due to the dynamic friction coefficient of less than 0.15, so that it can simultaneously satisfy the anti-fingerprint property, the anti-magic maker property and slippability.

The optical functional film of the present invention comprises the substrate, the optical functional layer and the antifouling layer. In the following, each component of such an optical functional film of the present invention will be explained.

### 1. Antifouling Layer

The antifouling layer used in the present invention is formed on the below-mentioned optical functional layer, and it can take two modes according to formed states. That is, the antifouling layer can take the two modes: one formed in a filmy manner on the optical functional layer with a below-mentioned material for forming the antifouling layer, and another bled on an outermost surface of the above optical functional layer after mixing the material into the optical functional layer. In the present invention, either of the above two modes can be employed.

The antifouling layer used in the present invention has the below-mentioned characteristics together with an elementary ratio Si/C between a silicon element (Si) and a carbon element (C) of 0.25 to 1.0 and an elementary ratio F/C between a fluorine element (F) and the carbon element (C) of 0.10 to 1.0:

a. the liquid paraffin contact angle of not less than 65° and the liquid paraffin falling angle of not more than 15°,

b. the black magic marker contact angle of not less than 35° and the black magic marker falling angle of not more than 15°, and

c. the dynamic friction coefficient of less than 0.15.

In the following, such an antifouling layer will be explained in detail.

### (1) Liquid Paraffin Contact Angle and Liquid Paraffin Falling Angle

The liquid paraffin contact angle and the liquid paraffin falling angle evaluate attachment easiness and wiping easiness of the antifouling layer used in the present invention by measuring the attachment easiness and wiping easiness of a lipophilic component represented by the liquid paraffin. In the following, such a liquid paraffin contact angle and a liquid paraffin falling angle will be explained.

### (a) Liquid Paraffin Contact Angle

The liquid paraffin contact angle is a contact angle measured through forming a liquid drop by contacting the liquid paraffin on a surface of the antifouling layer.

Since the fingerprint attached through the direct contact with a human hand is a fat and oil component and the lipophilic material, measurement of the contact angle of the liquid paraffin as one of similarly lipophilic materials can give an index of the attachment easiness of the fingerprint. Here, it is meant that the larger the contact angle, the less compatible and the less attachable is the lipophilic material with respect to the surface of the antifouling layer. That is, the larger the contact angle of the liquid paraffin is, the less attachable the fingerprint becomes.

In the present invention, the liquid paraffin contact angle is characterized by not less than 65°, among them preferably in a range of not less than 70°, and particularly preferably not less than 75°. For, if it is less than the above range, a fingerprint is easily attached to the antifouling layer when it is used in the optical functional film of the present invention.

Note that in a method for measuring the above liquid paraffin contact angle, a 3.0 mm-diameter liquid drop of the liquid paraffin formed at a needle tip was contacted on an antifouling layer horizontally placed in a dried state (20° C.-65% RH), and the liquid drop of the liquid paraffin was formed on the antifouling layer. The contact angle is an angle formed between a tangential line to a surface of the liquid drop of the liquid paraffin and the surface of the antifouling layer at a point where the antifouling layer and the liquid drop of the liquid paraffin contact, and this angle is an angle on a side containing the liquid drop of the liquid paraffin.

Such a contact angle can be measured by using a fully automated contact angle meter (manufactured by Kyowa Interface Science Co., Ltd., DM700), for example.

### (b) Liquid Paraffin Falling Angle

The liquid paraffin falling angle is evaluation of an inclination angle when a liquid drop starts to slip downwardly in the case that the liquid drop is formed by contacting the liquid paraffin onto a surface of the antifouling layer and thereafter the antifouling layer is gradually inclined. The liquid paraffin falling angle as obtained by such a measuring method measures an attachment force of the liquid paraffin to the surface of the antifouling layer, and can be taken as an index of the wiping easiness of the fingerprint. Here, it is meant that the smaller the falling angle, the weaker the attachment force, so that the antifouling layer has a property that the fingerprint is easily wiped off. The liquid paraffin falling angle in the present invention is characterized by not more than 15°, among them preferably in a range of not more than 10°, and particularly preferably in a range of not more than 5°. If the liquid paraffin falling angle is more than the above range, the fingerprint is difficult to be wiped off when the antifouling layer is used in the optical functional film of the present invention.

Note that as to the above liquid paraffin contact angle, a 3.0 mm-diameter liquid drop of the liquid paraffin formed at a needle tip was contacted on an antifouling layer horizontally placed in a dried state (20° C.-65% RH), and the liquid drop of the liquid paraffin was formed on the antifouling layer. Then, the inclination angle of the antifouling layer is increased at a rate of 2°/s, and an inclination angle at which the liquid drop of the liquid paraffin starts to slip downwardly is taken as the liquid paraffin falling angle.

Such a falling angle can be measured by using the fully automated contact angle meter (manufactured by Kyowa Interface Science Co., Ltd., DM700), for example.

### (c) Liquid Paraffin Contact Angle and Liquid Paraffin Falling Angle

The liquid paraffin contact angle and the liquid paraffin falling angle used in the present invention represent the attachment easiness of the fingerprint and the wiping easiness of the finger print, respectively. When they are both in the above-mentioned ranges, the fingerprint is difficult to be attached and is easily wiped off, so that the antifouling layer has excellent anti-fingerprint property.

### (2) Black Magic Marker Contact Angle and Black Magic Marker Falling Angle

The black magic marker contact angle and the black magic marker falling angle evaluate the attachment easiness and the wiping easiness of the oily black magic marker, and evaluate writing easiness and wiping easiness of letters and the like with the oily black magic marker onto the antifouling layer to be used in the present invention. In the following, such a black magic marker contact angle and such a black magic marker falling angle will be explained.

### (a) Black Magic Marker Contact Angle

The black magic marker contact angle means a contact angle measured in the case that an ink of an oily black magic marker as the black magic marker onto a surface of the antifouling layer and the liquid drop of the ink of the magic marker is formed.

Measurement of such a black magic marker contact angle can afford an index of compatibility between the black magic marker and the antifouling layer, that is, the attachment easiness. Here, it is meant that the larger the contact angle, the more difficult is the fingerprint attached to the antifouling layer.

The black magic marker contact angle in the present invention is characterized by not less than 35°, among them preferably in a range of not less than 40°, and particularly preferably in a range of not less than 50°. If it is less than the above range, the black magic marker is more easily attached when the antifouling layer is used in the optical functional film of the present invention.

Note that the black magic marker contact angle was measured by the same method as described in Section “(a) Liquid paraffin contact angle” of the above “(1) Liquid paraffin contact angle and liquid paraffin falling angle”, except that a liquid drop was formed by using the oily black magic marker ink. Here, a generally commercially available oily black magic marker ink can be used as the above oily black magic marker ink, and specifically MHJ60-T1 black (manufactured by Teranishi Chemical Industry Co., Ltd.) can be used.

### (b) Black Magic Marker Falling Angle

The black magic marker falling angle evaluates, as a falling angle, an inclination angle at which a liquid drop starts to slip downwardly when an antifouling layer is gradually inclined in a case where the liquid drop of an oily black magic marker is formed by contacting an ink of the black magic marker on a surface of the antifouling layer.

The black magic marker falling angle obtained by such a measuring method measures an attachment force of the black magic marker to the surface of the antifouling layer, and can be taken as an index of the wiping easiness of the black magic marker. Here, it is meant that the smaller the falling angle, the weaker the adhesion force, so that the antifouling layer has a property that the fingerprint is easily wiped off. The black magic marker falling angle in the present invention is characterized by not more than 15°, among them preferably in a range of not more than 10°, and particularly preferably in a range of not more than 5°. If it is more than the above range, the attachment force of the black magic marker is strong, so that the black magic marker is difficult to be wiped off when the antifouling layer is used in the optical functional film.

Note that the black magic marker contact angle was measured by the same method as described in Section “(b) Liquid paraffin falling angle” of the above “(1) Liquid paraffin contact angle and liquid paraffin falling angle”, except that a liquid drop was formed by using the oily black magic marker ink.

Further, the same one as in the above “(a) black magic marker contact angle” can be used as the black magic marker ink.

### (c) Black Magic Marker Contact Angle and Black Magic Marker Falling Angle

The black magic marker contact angle and the black magic marker falling angle used in the present invention represent the attachment easiness and the wiping easiness of the oily black magic marker, respectively. When the black magic marker contact angle and the black magic marker falling angle are in the above-mentioned ranges, respectively, the black magic marker is difficult to be attached and is easily wiped off when attached, so that the antifouling layer has excellent anti-magic maker property.

### (3) Dynamic Friction Coefficient

The dynamic friction coefficient used in the present invention represents slipping property which is an index of wiping easiness when a fingerprint or a magic marker attached to the surface of the above antifouling layer is wiped off with a cloth or the like, for example. Here, when the dynamic friction coefficient is small, the surface of the antifouling layer is slippery, and the fingerprint and the magic marker ink are easily wiped off with the cloth or the like. The dynamic friction coefficient in the present invention is characterized by less than 0.15, among them preferably in a range of not more than 0.10, and particularly preferably in a range of not more than 0.08. If it is more than the above range, the fingerprint and the like are difficult to be wiped off.

Note that a value measured by HEIDON HHS-2000 Dynamic Friction tester in a dried state (20° C.-65% RH) with a 10 mmφ stainless steel ball under a load of 200 g and at a speed of 5 mm/s was used as the dynamic friction coefficient.

### (4) Other Characteristics

The antifouling layer used in the present invention has elementary ratios at the surface that the ratio Si/C between a silicon element (Si) and a carbon element (C) is 0.25 to 1.0 and the ratio F/C between a fluorine element (F) and the carbon element (C) is 0.10 to 1.0. So long as the antifouling layer has the above-mentioned characteristics, it is not particularly limited, and may have other characteristics. In the present invention, for example, a water contact angle may be not less than 100°, and a surface roughness (Ra) may be not more than 2 nm.

The above water contact angle represents compatibility with water, that is, attachment easiness of water. It means that the antifouling layer has a characteristic that, when the contact angle is large, water is difficult to attach. Recently, displays and the like have come to be used not only indoors but also outdoors, so it is required that images can be well recognized even upon exposure to wind and rain. When the water contact angle is not less than 100° to cope with such needs, water is difficult to attach and easily wiped off, so that the antifouling layer can possess excellent water repellency. In the present invention, the water contact angle of not less than 100° suffices, among them preferably in a range of not less than 105°, particularly preferably not less than 110°. If it is smaller than the above range, sufficient water repellency cannot be exhibited, and there is a possibility that an image displayed in a display is not well recognized. Note that the water contact angle was measured by the same method as described in Section “(a) Liquid paraffin contact angle” of the above “(1) Liquid paraffin contact angle and liquid paraffin falling angle”, except that a liquid drop was formed by using distilled water.

The surface roughness (Ra) of the antifouling layer shows absence and presence of unevenness at the surface of the antifouling layer. It is meant that if this value is large, there is big unevenness at the surface. If the above surface roughness (Ra) is large, there occur problems that abrasion resistance and wear resistance are weak and dirt is likely to be attached. On the other hand, if the surface roughness (Ra) is not more than 2 nm, the antifouling layer can be excellent in the abrasion resistance and the wear resistance so that dirt may be difficult to be attached to concave and convex portions of the surface of the antifouling layer. In the present invention, the surface roughness (Ra) of not more than 2 nm suffices, among them preferably in a range of not more than 1.5 nm, and particularly preferably in a range of not more than 1 nm. If it is more than the above range, the abrasion resistance and the wear resistance are likely to be deteriorated, and dirt is likely to be attached to the surface of the antifouling layer.

Here, the above surface roughness (Ra) represents the average surface roughness, an atomic force microscope (manufactured by Nihon Veeco K.K., Nanoscope IIIa) was used, and DMLS-633G was used as a scanner. A MPP-21100-10 made of silicon was used as a cantilever. They can be purchased from Nihon Veeco K.K., and are generally used. A tapping mode was adopted as an observation mode. As the cantilever for the observation, a new one was always used so that reduction in resolution with contamination through a probe may be avoided. Further, in order to prevent abrading deterioration, a test was performed under a condition that a load applied to the probe was as small as possible within a range in which the resolution power was not sacrificed. The surface roughness was measured in a very small area of 1 μm×1 μm in a dried state (20° C.-65% RH), and observation was performed at a resolution power of 256 pixels×256 pixels. Observation was performed at a scanning speed of 1.0 Hz, but it is not necessarily limited to this speed, so long as the resolution power is not deteriorated. Inclination of data was corrected by an annexed software after the observation, and thereafter the surface roughness was evaluated by the annexed software. The surface roughness (Ra) was obtained by the following calculation formula (1).

$$\begin{matrix}( Formula 1 ) & \\ {R}_{a} = \frac{1}{{S}_{0}} {\int }_{{Y}_{B}}^{{Y}_{T}} {\int }_{{X}_{L}}^{{X}_{R}} \vert F ( X , Y ) - {Z}_{0} \vert d X d Y & ( 1 )\end{matrix}$$

The average surface roughness Ra value (nm) obtained by the above calculation formula (1) is three-dimensionally expanded by applying a center line average roughness Ra defined in JIS B0601 with respect to a surface measured, and is expressed as “a value obtained by averaging absolute values of deviations from a standard surface to designated surfaces”. Here, meanings of S0, F(X, Y), XL to XR, YB to YT and Z0 used in the above calculation formula (1) are as follows.

Ra: The average surface roughness (nm)

S0: An area (|XR−XL|×|YT−YB|) on the assumption that the surface measured is ideally flat

F(X, Y): A height at a measuring point (X, Y) (X is an X coordinate and Y is a Y coordinate)

XL to XR: A region of the X coordinate in the surface measured

YB to YT: A region of the Y coordinate in the surface measured

ZO: The average height within the surface measured

### (5) Antifouling Layer

Elementary ratios at the surface of the antifouling layer used in the present invention are not particularly limited, so long as the above-mentioned characteristics are possessed, and the ratio Si/C between a silicon element (Si) and a carbon element (C) is 0.25 to 1.0 and the ratio F/C between a fluorine element (F) and the carbon element (C) is 0.10 to 1.0. The present invention is characterized in that Si/C is 0.25 to 1.0 and F/C is 0.10 to 1.0. Among them, the above elementary ratios are preferably that Si/C is in a range of not less than 0.3 and F/C is in a range of not less than 0.15, and particularly preferably Si/C is in a range of not less than 0.35 and F/C is in a range of not less than 0.20. If the ratios are smaller than the above ranges, the above-mentioned characteristics are not fully exhibited. Further, if the elementary ratio of Si/C exceeds 1.0, compatibility with other component becomes extremely poor, so there occur adverse effects that repelled portions or uneven portions are formed in a coated face or it is whitened. Furthermore, reduction in film strength of the outermost surface layer is provoked. If the elementary ratio of F/C exceeds 1.0, similar troubles occur, so it is unfavorable.

Note that an ESCA (Angle-resolved type micro region X-ray photoelectron spectrometer Theta Probe (manufactured by Thermo Electron K.K.) was used to measure the above elementary ratios, and measured results of the surface of the above antifouling layer under the following condition were used. In the measurement according to the X-ray photoelectron spectrometer (XPS), elements in a range of about 1 nm to 10 nm from the surface of the antireflection film are detected.

### (Measuring Condition)

X-ray source: Monochromatic AlKα

Measured area: 400 μmφ

X-ray output: 100 W

As a material to constitute an antifouling layer having such elementary ratios at a surface, a material comprising silicon-containing compound and a fluorine-containing compound can be recited. Among them, a silicon-containing compound having a siloxane group and a fluorine-containing compound containing at least one of a perfluoroalkyl group and a perfluoroalkyl ether group is preferred. Since both of the compounds have generally low surface tensions and tend to exist at the surface, they are likely to bleed at the surface even if they are mixed with other component. Thus, it is easy to adjust the abundance ratio.

As the silicon-containing compound having the siloxane group to be used in the present invention, one represented by the following general formula (1) can be employed. In the formula, Ra denotes an alkyl group having 1 to 20 carbons such as a methyl group, Rb denotes an alkyl group having 1 to 20 carbons, an alkoxy group having 1 to 3 carbons or a polyether-modified group, Rb being non-substituted or substituted by an amino group, an epoxy group, a carboxyl group, a hydroxyl group or a (metha)acryloyl group, and Ra and Rb may be identical with or different from each other. Further, “m” is an integer of 0 to 250, and “n” is an integer of 0 to 250.

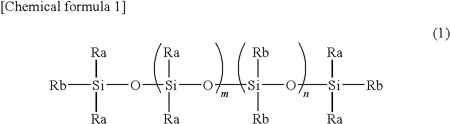

In the present invention, among the compounds having the structure represented by the above general formula (1), particularly, X-22-174DX and X-22-2426 having one terminal modified with a (metha)acryloyl group (both manufactured by Shin-Etsu Chemical Co., Ltd.) or X-22-164A and X-22-164E having both terminals modified with (metha)acryloyl groups (both manufactured by Shin-Etsu Chemical Co., Ltd.) can be preferably used.

The fluorine-containing compound to be used in the present invention is not particularly limited, so long as it contains at least one of a perfluoroalkyl group represented by C_{d}F2_{d+1} (“d” is an integer of 1 to 21) and a perfluoroalkyl ether group represented by —(CF₂—CF₂—O)—. For example, a polymer of a fluorine-containing monomer, a copolymer of the fluorine-containing monomer and a monomer containing no fluorine and the like can be used.

Among them, a compound having a perfluoro polyether group represented by the following general formula (2) can be preferably used in the present invention. In the formula, “p” is an integer of 0 to 2000, and “q” is an integer of 0 to 2000.

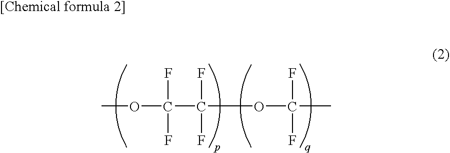

Among the compound having the perfluoro polyether group represented by the above general formula (2), particularly a perfluoro polyether compound having both terminals or one terminal modified with a (metha) acryloyl group is preferably used in the present invention. Specifically, recitation is made of MD700 and 5101X having both terminals modified with urethane methacrylate (both manufactured by Solvay Solexis K.K.) and 5090X having both terminals modified with urethane acrylate (manufactured by Solvay Solexis K.K.) are recited.

The materials to constitute the antifouling layer to be used in the present invention are not particularly limited, so long as they comprise the silicon-containing compound having the siloxane group and the fluorine-containing compound containing at least one of the perfluoroalkyl group and the perfluoroalkyl ether group. They may be used as a mixture, or they may be contained in an identical molecule through copolymerization thereof. Any of both can be favorably used in the present invention, but one containing both in the identical molecule is preferred, because the elementary ratios in the surface of the above antifouling layer are easily adjusted.

In the present invention, the ratio between the silicon-containing compound and the fluorine-containing compound is not particularly limited, so long as Si/C and F/C in the surface of the antifouling layer are within the above-mentioned ranges. The ratio is appropriately selected depending upon kinds of the compounds used.

The film thickness of the antifouling layer used in the present invention is not definitely specified in some cases when the antifouling layer is formed by bleeding the material to constitute the antifouling layer onto the outermost surface of the below-mentioned optical functional layer. In a case that the antifouling layer is formed in a filmy manner on the below-mentioned optical functional layer, it is preferably in a range of 1 nm to 30 nm, and most preferably in a range of 5 nm to 10 nm. If it is thicker than the above range, the optical characteristics are affected, so that when the antifouling layer is used in a display or the like, images may not be recognized well.

As a method for forming the antifouling layer in the present invention, recitation can be made of a method in which a liquid for coating an antifouling layer is prepared by dissolving or dispersing the above silicone-containing compound having the siloxane group and the fluorine-containing compound containing at least one of the perfluoroalkyl group and the perfluoroalkyl ether group and the coating liquid is coated on the below-mentioned optical functional layer, followed by drying, or a method in which the compounds are dissolved in an optical functional layer-forming coating liquid for forming the below-mentioned optical functional layer, and they are bled out onto the surface of the optical functional layer through coating the below-mentioned substrate. In the present invention, the latter method is preferably used. Thereby, the thickness can be reduced, and further the number of steps can be reduced to improve the productivity.

### 2. Substrate

A substrate to be used in the present invention is not particularly limited, so long as when it is placed at a front face of an image display device such as a display, an image displayed in the display or the like can be well recognized. As such a substrate, a transparent film not absorbing a visible light can be used. As such a transparent film, for example, mention may be made of a triacetyl cellulose film, a polyethylene terephthalate film, a diacetyl cellulose film, an acetate butyrate cellulose film, a polyethersulfone film, a polyacrylic film, a polyurethane-based film, a polyester film, a polycarbonate film, a polysulfone film, a polyether film, a trimethylpentene film, a polyether ketone film, an acrylonitrile film, and a methacrylonitrile film Among the above transparent film materials, a monoaxially or biaxially stretched polyester film and the triacetyl cellulose film are preferably used in the present invention. This is because, the monoaxially or biaxially stretched polyester film is transparent and excellent in heat resistance, and the triacetyl cellulose film has no optical anisotropy.

The thickness of the above transparent film is not particularly limited, so long as images can be well recognized. Usually, it is in a range of 25 μm to 1000 μm.

### 3. Optical Functional Layer

The optical functional layer to be used in the present invention is formed between the above-mentioned substrate and antifouling layer, and it is not particularly limited, so long as it has a desired optical function when it is used at the surface of the display or the like. In the present invention, as the above optical functional layer, for example, mention may be made of: a hard coat layer having an abrasion-resistant function to prevent scratching on a surface of the film, a low refractive index layer having an antireflective function, an antistatic layer having a dirt attachment-preventing function through preventing electrostatic charging, and an antidazzle layer having a function to reduce reflection of a fluorescent lamp or the like onto a screen through diffusing the reflection by diffusing the reflection of a outside light. Among such optical functional layers, one in which at least one layer is laminated is recited.

As a laminating order of the optical functional layers to be used in the present invention, an antistatic layer, a hard coat layer, an antidazzle layer and a low refractive index layer are usually laminated in this order from the substrate side. Therefore, as the layer construction of the optical functional layer, for example, mention may be made of: a substrate/an antistatic layer, a substrate/a hard coat layer, a substrate/a low refractive index layer, a substrate/an antistatic layer/a hard coat layer, a substrate/a hard coat layer/a low refractive index layer, a substrate/an antistatic layer/a hard coat layer/a low refractive index layer, a substrate/an antidazzle layer, a substrate/an antidazzle layer/a low refractive index layer, a substrate/an antidazzle layer/a hard coat layer/a low refractive index layer, a substrate/an antistatic layer/an antidazzle layer, a substrate/an antistatic layer/an antidazzle layer/a low refractive index layer, and a substrate/an antistatic layer/an antidazzle layer/a hard coat layer/a low refractive index layer.

### (1) Antistatic Layer

The antistatic layer to be used in the present invention can prevent dirt attachment through an antistatic effect and afford an electromagnetic wave shielding effect in case that the optical functional film of the present invention is used in a CRT.

As such an antistatic layer, a resin composition in which electroconductive fine particles are dispersed is used.

As the electroconductive fine particles to be used in the above antistatic layer, for example, indium-tin oxide doped with antimony (ATO) or indium-tin oxide (ITO), organic compound fine particles surface-treated with gold and/or nickel can be recited. As an antistatic agent, various surface active agent type antistatic agents including: a cationic antistatic agent such as a quaternary ammonium base, an anionic antistatic agent such as a sulfonic acid base or a sulfuric acid ester base, a nonionic antistatic agent such as a polyethylene glycol-based agent, and further a polymeric type antistatic agent in which the above-mentioned antistatic agent is polymerized may be used. Furthermore, an electroconductive polymer such as polyacetylene, polypyrrole, polythiophene, polyaniline, poly (phenylene vinylene), polyacene or a derivative of each of them may be used.

The resin composition to be used in the antistatic layer is not particularly limited, so long as it is a transparent resin composition which can include the above electroconductive fine particles. For example, a thermoplastic resin, a thermosetting resin or a photosensitive resin can be used.

A method for producing the antistatic layer to be used in the present invention is not particularly limited, so long as it can be formed in a uniform film thickness, and a usual coating method can be used.

Furthermore, in the present invention, the hard coat layer, the low refractive index layer and the antidazzle layer can also each have a function as an antistatic layer through adding the above-mentioned electroconductive fine particles thereinto.

### (2) Hard Coat Layer

The hard coat layer to be used in the present invention is to afford an abrasion-resistant effect so that the surface of the optical functional film of the present invention may not be scratched. In the present invention, the above hard coat layer is one exhibiting a hardness of not less than H in a pencil hardness test described in JIS5600-5-4:1999.

A material to constitute such a hard coat layer is not particularly limited, so long as it has transparency and affords a hard coat property. For example, a thermoplastic resin, a thermosetting resin, or an ionized radiation curable type resin can be used. Among them, from a merit that an excellent hard coat property can be attained, a reaction curable type resin, that is, the thermosetting type resin and/or the ionized radiation curable type resin is preferably used in the present invention. Particularly, the ionized radiation curable type resin is preferably used as a binder resin of the hard coat layer. This is because, it is excellent in energy efficiency, reduction in heat damage upon other member, etc.

As the ionized radiation curable type resin composition which is suitable to form the hard coat layer to be used in the present invention, use may be made of a resin composition preferably having an acrylate-based functional group, for example, a polyester resin having a relative low molecular weight, a polyether resin, a polyether resin, an acrylic resin, an epoxy resin, a urethane resin, an alkyd resin, a spiroacetal resin, a polybutadiene resin, a polythiol polyether resin, a multivalent alcohol, a di(metha)acrylate such as ethylene glycol di(metha)acrylate, or pentaerythritol di(metha)acrylate monostearate; a tri(metha)acrylate such as trimethylol propane tri(metha)acrylate, or pentaerythritol tri(metha) acrylate, a monomer such as a polyfunctional compound including a polyfunctional (metha)acrylate such as a pentaerythritol tetra(metha)acrylate derivative or dipentaerythritol penta(metha)acrylate, an oligomer such as an epoxy acrylate, or an urethane acrylate.

As a photopolymerization initiator to be used in the above ionized radiation curable type resin composition, a photo-radical initiator, a photo-cationic initiator or the like is appropriately selected to meet a reaction type of the above ionized radiation curable type resin composition. Although the photopolymerization initiator is not particularly limited, for example, a photo-radical initiator, a photo-cationic initiator or the like is appropriately selected as the photopolymerization initiator to meet a reaction type of the ionized radiation curability of a binder component.

Such a photopolymerization initiator is not particularly limited; mention may be made of, for example, acetophenones, benzophenones, ketals, anthraquinones, disulfide compounds, thiuram compounds, and fluoroamine compounds. More specifically, mention may be made of, for example, 1-hydroxy-cyclohexyl-phenyl-ketone, 2-methyl-1-[4-(methylthio)phenyl]-2-morpholino propane-1-one, benzyl dimethyl ketone, 1-(4-dodecylphenyl)-2-hydroxy-2-methylpropane-1-one, 2-hydroxy-2-methyl-1-phenylpropane-1-one, 1-(4-isopropyl phenyl)-2-hydroxy-2-methylpropane-1-one, 2-hydroxy-1-{4-[4-(2-hydroxy-2-methyl-propionyl)-benzyl]phenyl}-2-methyl-propane-1-one, and benzophenone. Among them, 1-hydroxy-cyclohexyl-phenyl-ketone and 2-methyl-1-[4-(methylthio)phenyl]-2-morpholino propane-1-on are preferably used in the present invention, because even a small quantity thereof initiates and promotes the polymerization reaction through irradiation of ionized radiation. Either one of them can be used singly, or they can be used in combination. Commercial products are available for them, and for example, 1-hydroxy-cyclohexyl-phenyl-ketone is available in a commercial name of Irgacure 184® from Chiba Specialty Chemicals K.K.

The thickness of the hard coat layer to be used in the present invention is not particularly limited, so long as it can exhibit abrasion resistance and has a sufficient strength. After curing, it is preferably in a range of 0.1 μm to 100 μm, among them, preferably in a range of 0.8 μm to 20 μm. If it is thinner than the above range, a sufficient hard coating performance is not be obtained, whereas if it is thicker than the above range, the hard coat is likely to be cracked with an external impact.

A method for forming the hard coat layer to be used in the present invention is not particularly limited, so long as it can be formed in a uniform thickness, and a usual coating method can be used.

### (3) Antidazzle Layer

The antidazzle layer to be used in the present invention is a layer having finely uneven shape at a surface to provide an antidazzle function.

The antidazzle layer is formed, which contains translucent fine particles to afford an antidazzle property and a binder to afford adhesion to a substrate and an adjacent layer and further contains an additive such as a leveling agent, an inorganic filler, etc. to adjust the refractive index, to prevent crosslinkage shrinkage and to afford high press-fit strength.

Each of the translucent fine particles is not particularly limited, and inorganic and organic ones can be used. As a specific example of the fine particles formed of the organic material, plastic beads can be recited. As the plastic beads, mention may be made of styrene beads (refractive index 1.60), melamine beads (refractive index 1.57), acryl beads (refractive index 1.50 to 1.53), an acryl-styrene beads (refractive index 1.54 to 1.58), benzoguanamine beads, benzoguanamine-formaldehyde condensation beads, polycarbonate beads, and polyethylene beads. The above plastic beads preferably have hydrophobic groups at surfaces thereof, and styrene beads can be recited, for example. As the inorganic fine particles, amorphous silica, inorganic silica beads, etc. can be recited.

Particle diameters of the translucent fine particles to be used in the present invention are not particularly limited, so long as they can be uniformly dispersed in the binder to attain desired unevenness. Particles being 0.5 μm to 8 μm are preferably used.

Further, the content of such translucent fine particles to the binder is preferably employed in a range of 1 part by mass to 15 parts by mass per 100 parts by mass of the binder.

The binder capable of being employed in the antidazzle layer to be used in the present invention is not particularly limited, so long as it is a transparent resin. For instance, a thermoplastic resin, a reaction-curable type resin such as a thermosetting resin, or an ionized radiation-curable type resin can be used.

The film thickness of the antidazzle layer to be used in the present invention is not particularly limited, so long as it affords a desired antidazzle effect. The film thickness can be appropriately set depending upon the kind of the translucent fine particles used, the usage of the optical functional film of the present invention, etc.

The antidazzle layer may be a single layer or a multilayer. In case that the antidazzle layer is a multilayer, it is preferably composed of a underlying uneven layer and a surface shape-adjusting layer provided on this underlying uneven layer. The surface shape-adjusting layer is a layer to adjust the surface shape of the underlying uneven layer into a more appropriate uneven shape. The underlying uneven layer in the case that the antidazzle layer is a multilayer has a uneven surface shape, and can be obtained by the same method as in the case with the dazzle layer which is an uneven single layer having an uneven surface shape.

The antidazzle layer used in the present invention is usually formed by a method in which the above translucent fine particles are mixed into the above binder and a resulting coating liquid is coated.

When in use, settled translucent fine particles need to be well stirred and dispersed in such a coating liquid. In order to avoid such inconvenience, silica beads having particle diameters of not more than 0.5 μm, preferably 0.1 μm to 0.25 μm may be added as an antisettling agent into the coating liquid. The more this silica beads added, the more effective the antisettling performance for the organic filler, but it adversely affects the transparency of the coated film. Therefore, the silica beads are preferably added in a settling-preventable range without damaging the transparency of the coated film, that is, in around less than 0.1 part by mass per 100 parts by mass of the binder.

### (4) Low Refractive Index Layer

The low refractive index layer in the present invention is not particularly limited, so long as it can afford a antireflective effect upon the optical functional layer. For example, a low refractive index layer comprising low refractive index fine particles and a binder component can be recited. The low refractive index fine particles are fine particles having a refractive index lower than that of the binder component.

### (Low Refractive Index Fine Particles)

Low refractive index fine particles forming cores to be used in the present invention are fine particles having a refractive index lower than that of the binder component to be used in the coating composition. In the present invention, the refractive index of the low refractive index fine particles is preferably not more than 1.44, more preferably not more than 1.40. Thereby, sufficiently low refractive property can be afforded.

As the low refractive index fine particles to be used in the present invention, fine particles having voids, metal fluoride fine particles having a low refractive index and the like are recited.

In the present invention, the above fine particles having the voids mean fine particles forming a structure in which a gas is filled inside the fine particles and/or a porous structural body containing a gas. When the gas is air having a refractive index of 1.0, the refractive index decreases in proportion to the occupying percentage inside the fine particles as compared with the refractive index of the fine particles themselves. Furthermore, the present invention also encompasses fine particles which can form a nanoporous structure at least partially inside and/or in a surface depending upon the configuration, the structure, the aggregated state and the dispersed state inside the film of the fine particles.

In the low refractive index fine particles to be used in the present invention, a material of the void-possessing fine particles may be either an inorganic material or an organic material. For example, a metal, a metal oxide and a resin can be recited. Among them, silicon oxide (silica) fine particles are preferably used. The above silica fine particles are not limited to any of crystalline, sol and gel states or the like.

As specific examples of the inorganic fine particles having the voids, a composite oxide sol or hollow silica fine particles disclosed in JP-A 7-133105 and JP-A 2001-233611 are recited. Among them, the hollow silica fine particles prepared by using a technique disclosed in JP-A 2001-233611 are preferred. Since the inorganic fine particles having the voids have high hardness, when the low refractive index layer is formed by mixing them with the binder component, layer strength thereof is increased, and the refractive index can be adjusted in a range of around 1.20 to 1.44.

Specifically, the inorganic fine particles having the voids, such as the above hollow silica fine particles, can be produced by the following first to third steps.

That is, in the first step, alkaline aqueous solutions of a silica raw material and an inorganic oxide raw material other than silica were separately prepared, or an aqueous mixed solution thereof is prepared. Next, the obtained aqueous solution or solutions are gradually added into an alkaline aqueous solution having not less than pH10, depending upon compounding ratios of an intended composite oxide under stirring. Instead of the first step, the dispersion liquid preliminarily containing seed particles is used as a starting material.

Next, in the second step, at least a part of an element or elements other than silicon and oxygen are selectively removed from colloid particles composed of the composite oxide obtained in the above step. Specifically, the element(s) in the composite oxide is (are) removed through dissolution by using a mineral acid or an organic acid. Alternatively, the element(s) is (are) removed by ionic exchange through being contacted with a cation exchange resin.

Subsequently, in the third step, a hydrolyzable organic silicon compound, silicic acid liquid or the like is added to this colloidal particles of the composite oxide from which the element(s) is (are) partially removed, so that surfaces of the colloidal particles are coated with a polymer of the hydrolyzable organic silicon compound, the silicic acid liquid or the like. The composite oxide sol described in the above publication can be produced in this way.

Further, as the fine particles capable of forming the nanoporous structure inside and/or at least part of the surface of the formed low refractive index layer, a gradually releasable material which is produced to increase the specific surface area and adapted to adsorb various chemical materials on a filling column and a surface porous portion, porous fine particles to be used for fixing a catalyst, a dispersion body or an aggregated body of hollow fine particles to be incorporated into a heat insulating material or a low dielectric material can be recited in addition to the above silica fine particles. As such specific examples, fine particles within a preferable particle diameter range in the present invention can be selectively used from commercialized products of an aggregated body of porous silica fine particles of Trade names: Nipsil and Nipgel manufactured by Nihon Silica Co., Ltd., and from colloidal silica UP series (trade name) having a silica fine particle-chain connected structure manufactured by Nissan Chemicals Industries, Ltd.

On the other hand, as a specific example of the organic fine particles having the voids, hollow polymer fine particles prepared by using a technique disclosed in JP-A 2002-80503 is preferably recited. Concretely, the hollow polymer fine particles can be produced by dispersing, into an aqueous solution of a dispersion stabilizer, a mixture of (i) at least one kind of a crosslinkable monomer, (ii) an initiator, (iii) a polymer obtained from at least one kind of a crosslinkable monomer or a copolymer of at least one kind of a crosslinkable monomer and at least one kind of a monofunctional monomer and a poorly water-soluble solvent having a low compatibility with (i) to (iii) and performing a suspension polymerization. Here, the crosslinkable monomer is one having two or more polymerizable reaction groups, and the monofunctional monomer is one having one polymerizable reaction group.

When the fine particles having the voids are used as the low refractive index fine particles in the present invention, the refractive index is preferably in a range of 1.20 to 1.44, and particularly preferably in a range of 1.22 to 1.40. If it is greater than the above range, the refractive index cannot be sufficiently lowered, whereas if it is smaller than the above range, it becomes difficult to ensure the strength of the fine particles themselves.

On the other hand, the material of the fine particles of a metal fluoride to be used in the present invention is not particularly limited, so long as it has a low refractive index. For example, magnesium fluoride, aluminum fluoride, potassium fluoride, and lithium fluoride can be recited.

Further, when the fine particles of the metal fluoride are used as the low refractive index fine particles in the present invention, the refractive index is preferably in a range of 1.30 to 1.44, particularly preferably in a range of 1.33 to 1.40. If it is larger than the above range, the refractive index can be sufficiently lowered. Thus, from the standpoint that the refractive index of the low refractive index layer can be sufficiently lowered, the above range is preferred.

The shape of the fine particle may be anyone of a spherical shape, a chain-like shape, a needle-like shape, a plate-like shape, flaky shape, a rod-like shape, a fibrous shape and a resinous shape.

The average particle diameter of the low refractive index fine particles is preferably not less than 1 nm and not more than 100 nm, more preferably the lower limit is not less than 10 nm and the upper limit is not more than 50 nm. If the average particle diameter of the fine particles is more than 100 nm, the transparency may be damaged. On the other hand, if the average particle diameter of the fine particles is less than 1 nm, it is feared that the dispersion of the fine particles may become difficult. When the average particle diameter of the fine particles is within this range, excellent transparency can be afforded on the low refractive index layer.

### (Binder Component)

The binder component to be used in the present invention is not particularly limited, so long as it can be used to uniformly disperse the above-mentioned low refractive index fine particles and can afford excellent film formability, and adhesion for the substrate and the adjacent layer.

Such a binder component is not particularly limited, so long as it has transparency when solidified or cured. For example, use may be made of: a reactive binder component represented by a photocurable binder component to be cured with electromagnetic waves or energetic particle beams such as a visible light, ultraviolet rays, or an electron beam; a reactive binder component represented by a thermosetting binder component to be cured with heat; and a non-reactive binder component represented by a thermoplastic resin to be solidified through drying or cooling without being sensitive to light, heat or the like.

Among them, the photocurable binder component, particularly an ionized radiation curable binder component is preferably used in the present invention. Thereby, a coating composition having excellent coatability can be prepared, and a uniformly coated film is easily formed in a large area. In addition, a coated film having a relatively high strength is obtained in this case by curing the binder component in the coated film through photopolymerization after coating.

As such an ionized radiation curable binder component, use can be made of a monomer, an oligomer and a polymer each of which has a polymerizable functional group that provokes a reaction to proceed with macromoleculization such as polymerization or dimerization directly upon irradiation with ionized radiation or indirectly upon undergoing an action of an initiator. In the present invention, a radically polymerizable group having an ethylenically unsaturated bond such as an acryl group, a vinyl group, or an ally group, or a photo-cationically polymerizable one such as an epoxy group-containing compound can be used.

As the above thermosetting binder component, use can be made of a monomer, an oligomer and a polymer each of which has a curing-reactive functional group and can be cured by heating and through proceeding with a macropolymerizing reaction such as a polymerization, or crosslinking between identical functional groups or other functional groups. Specifically, a monomer and a oligomer having an alkoxy group, a hydroxyl group, a carboxyl group, an amino group, an epoxy group, or a hydrogen bond-forming group can be recited.

In the present invention, as the ionized radiation curable binder component and the thermosetting binder component, one having polyfunctionality with not less than two polymerizable function groups within one molecule is preferable so that crosslinking bonds may be formed within the binder component.

As the above non-reactive binder component, mention may be made of polymerization non-reactive transparent resins having been heretofore used to form optical thin films, such as polyacrylic acid, polymethacrylic acid, polyacrylate, polymethacrylate, polyolefin, polystyrol, polyamide, polyimide, polyvinyl chloride, polyvinyl alcohol, polyvinyl butyral, and polycarbonate.

In the present invention, one kind of the above binder components may be used or two or more kinds thereof may be used in a mixed state. For example, the above ionized radiation curable binder component may be combined with the above thermosetting binder component or a polymerizable monomer, oligomer or polymer exhibiting other reaction type like the above non-reactive binder component.

The low refractory index fine particles and the binder component constituting the low refractive index layer to be used in the present invention are preferably compounded by compounding ratios of 3 parts by mass to 20 parts by mass for 10 parts by mass of the low refractive index fine particles.

The thickness of the low refractive index layer to be used in the present invention is not particularly limited, so long as it can exhibit a antireflective effect, but it is ordinarily in a range of 10 nm to 200 nm.

A method for forming the low refractive index layer to be used in the present invention is not particularly limited, so long as it can attain a uniform film thickness. For example, various vacuum film forming methods such as a vacuum deposition method, a sputtering method, and a thermal CVD method, or a publicly known method such as a wet coating by a sol-gel process can be used. Ordinarily, the low refractive index layer is formed by the wet coating in which a coating composition for the low refractive index layer comprising a coating liquid of the low refractive index fine particles and the binder component is coated.

The coating composition for the low refractive index layer comprises at least the low refractive index fine particles and the binder component, but may further contain a solvent, a photopolymerization initiator and other additive, if necessary.

### (Solvent)

The solvent contained in the coating composition for the low refractive index layer to be used in the present invention is not particularly limited, so long as it can uniformly dissolve or disperse the low refractive index fine particles, the binder component, and the like. An ordinary organic solvent can be used.

As such a solvent, use can be made of, for example, alcohols such as methanol, ethanol, and isopropyl alcohol: ketones such as methyl ethyl ketone, methyl isobutyl ketone, and cyclohexanone; esters such as ethyl acetate and butyl acetate; halogenated hydrocarbons; aromatic hydrocarbons such as toluene and xylene, or a mixture thereof.

Among them, a ketone-based organic solvent is preferably used in the present invention. When the coating composition according to the present invention is prepared by using the ketone-based solvent, the composition can be easily thinly and uniformly coated on the surface of the substrate, the evaporating speed of the solvent after coating is appropriate, and non-uniform drying hardly occurs, so that a coated film having a uniform thickness can be easily formed in a large area. A single solvent of one kind of the ketones, a mixed solvent of two or more kinds of the ketones, and a solvent which contains one or more kinds of the ketones and other solvent and which does not lose the property as the ketone solvent, can be used as the ketone-based solvent. A ketone solvent in which one or more kinds of the ketones preferably amount to not less than 70% by mass, and particularly not less than 80% by mass of the solvent, is used.

Further, the amount of the solvent is so appropriately adjusted that each component can be uniformly dissolved or dispersed, that no aggregation can occur during storage after the preparation, and that the concentration of the solvent may not be too thin at the time of coating. The use amount of the solvent is reduced within a range satisfying the above requirements so that the coating composition may be prepared at a high concentration and stored in a state not occupying a volume and that a necessary amount of the coating composition is taken out and diluted to a concentration suitable for the coating work. When the total amount of the solid matter and the solvent is taken as 100 parts by mass and if the solvent is used at a ratio of 50 parts by mass to 95.5 parts by mass relative to 0.5 parts by mass to 50 parts by mass of the entire solid matter, and more preferably at a ratio of 70 parts by mass to 90 parts by mass relative to 10 parts by mass to 30 parts by mass of the entire solid matter, the coating composition for the low refractive index layer, which is excellent particularly in dispersion stability and suitable for long-term storage, can be obtained.

### (Photopolymerization Initiator)

When the binder component to be used in the present invention is curable with ionized radiation, a photopolymerization initiator is desirably used to initiate the photopolymerization. As the photopolymerization initiator, the same materials as recited in the above paragraph “(2) Hard coat layer” can be used.

When the photopolymerization initiator is used, it is ordinarily preferably used in a ratio of 3 parts by mass to 8 parts by mass relative to 100 parts by mass of the ionized radiation curable binder component.

### (Others)

Besides the low refractive index fine particles and the binder component, other additives may be added in the present invention, if necessary. As such additives, use can be preferably made of oligomers having the number average molecular weight of not more than 20,000 (the number average molecular weight measured by the GPC method and calculated as polystyrene) such as an epoxy acrylate resin (“Epoxy ester” manufactured by Kyoeisha Chemical Co., Ltd. “Epoxy” manufacture by Showa Highpolymer Co., Ltd. or the like) or urethane acrylate resins which are obtained through polyaddition between various isocyanate and monomers having hydroxyl groups via urethane bonds (“SHIKOH®” manufactured by Nippon Synthetic Chemical Industry Co., Ltd. or “Urethane acrylate” manufactured by Kyoeisha Chemical Co., Ltd.). These monomers and oligomers are components having an effect of enhancing a crosslinking density of the coated film and the number average molecular weights are as small as not more than 20,000 with high fluidity, so that they have an effect to enhance the coatability of the coating composition for the low refractive index layer.

Further, a monomer containing fluorine and a polymer can be added as the binder to lower the refractive index.

Furthermore, as to the low refractive index layer to be used in the present invention, other refractive layers (a high refractive index layer and a medium refractive index layer) may be additionally provided on the above low refractive index layer on a side of the substrate. Thereby, when the high refractive index layer and the medium refractive index layer are used together with the low refractive index layer, reflection of light can be effectively prevented owing to differences in the refractive index among them.

The refractive indexes of these other refractive index layers are not particularly limited, so long as they are higher than that of the low refractive index layer, and they can be arbitrarily set in a range of 1.46 to 2.00. In the present invention, the medium refractive index layer means that its refractive index is higher than at least that of the low refractive index layer and that its refractive index is in a range of 1.46 to 1.80. The high refractive index layer means that its refractive index is higher than at least that of the medium refractive index layer when the former is used together with the latter and that its refractive index is 1.65 to 2.00.

The medium refractive index layer and the high refractive index layer to be used in the present invention are not particularly limited, so long as their refractive indexes are in the above-mentioned ranges. For example, those comprising super fine particles having a desired refractive index and a binder component can be recited.

As materials of such super fine particles, mention may be made of, for example, zinc oxide (1.90), titania (2.3 to 2.7), ceria (1.95), tin-doped indium oxide (1.95 to 2.00), antimony-doped tin oxide (1.75 to 1.85), yttria (1.87) and zirconia (2.10). Note that a figure inside a parenthesis is the refractive index of each super fine particle.

The refractive indexes of the medium refractive index layer and the high refractive index layer can be adjusted by an adjusting method in which the addition content of the super fine particles is adjusted, because the refractive index is generally determined by the content of the super fine particles.

Further, the average particle diameter of the super fine particles to be used in the present invention is not particularly limited, so long as they can form a layer having a desired refractive index, and it is ordinarily not more than 100 nm. Furthermore, the same as mentioned above for the above-mentioned low refractive index layer can be used as the binder component.

The film thickness of these other refractive index layers is preferably in a range of 10 nm to 300 nm, and more preferably 30 nm to 200 nm.

The formed positions of the above other refractive index layers (the high refractive index layer and the medium refractive index layer) are not particularly limited, so long as they are between the low refractive index layer and the substrate. They may be provided directly onto the substrate, but it is preferable that a hard coat layer is formed on the substrate and they are provided between the hard coat layer and the low refractive index layer. Thereby, the antireflective function can be more effectively exhibited.

In addition, when the super fine particles to be used in the present invention are electroconductive, the other refractive index layer formed by using such super fine particles (the high refractive index layer or the medium refractive index layer) has electroconductivity, so that it may also function as an antistatic layer.

The high refractive index layer or the medium refractive index layer in the present invention can be formed by a forming method similar to that for the above-mentioned low refractive index layer. They may be vapor deposition films of an inorganic oxide having a high refractive index, such as titania or zirconia, formed by a vapor deposition method such as a chemical vapor deposition method (CVD), or a physical vapor deposition method (PVD). Alternatively, they may be films in which fine particles of an inorganic oxide with a high refractive index, such as titania, are dispersed.

Meanwhile, the present invention is not limited to the above embodiments. The above embodiments are illustrative, but anything which has substantially the same construction and exhibits the same function and effect as those of the technical idea described in the claims of the present invention is encompassed by the technical scope of the present invention.

### EXAMPLES

Next, the present invention will be explained more specifically with reference to Examples and Comparative Examples.

### [Evaluation Method]

With respect to the optical functional films obtained in Examples and Comparative Examples, (1) a reflectance was measured, and (2) elementary ratios of a surface (Si/C and F/C), (3) a contact angle and a falling angle, (4) a dynamic friction coefficient of a surface, (5) the average surface roughness (Ra) of a surface and (6) an abrasion resistance evaluation test were measured. Results thereof are given in Table 1.

### (1) Measurement of the Reflectance

An absolute reflectance was measured by using a spectrophotometer (UV-3100PC) manufactured by Shimadzu Corporation. A minimum reflectance is given in Table 1. Note that as the minimum reflectance is taken a reflectance at the time when the film thickness of a low refractive index layer is so set to give a minimal value of the reflectance at a wavelength of around 550 nm.

### (2) Elementary Ratios at a Surface (Si/C and F/C)

Elementary ratios at a surface of a coated film were measured under the following condition by using an ESCA (Angle-resolved type micro area X-ray photoelectron spectrometer Theta Probe (manufactured by Thermo Electron K.K.)).

### (Measurement Condition)

X-ray source: Monochromatic AlKα
Measured area: 400 μmφ,
X-ray output: 100 W

### (3) Contact Angle and Falling Angle

A contact angle and a falling angle of a fluid paraffin and a black magic marker (MHJ60-T1 black, manufactured by Teranishi Chemical Industry Co., Ltd.) and a water contact angle on a surface were measured by using DM700 (manufactured by Kyowa Interface Science Co., Ltd.).

### (4) Dynamic Friction Coefficient on a Surface

A dynamic friction coefficient on a surface was measured in a dried state (20° C.-65% RH) with a HEIDON HHS-2000 Dynamic friction tester under the condition of a 10 mmφ stainless steel ball, a load of 200 g and at a speed of 5 mm/s.

### (5) Average Surface Roughness (Ra) of a Surface

The average surface roughness (Ra) of a surface was measured over an area of 1 μm×1 μm in a dried state (20° C.-65% RH) by using an atomic force microscope (manufactured by Nihon Veeco K.K., Nanoscope IIIa).

### (6) Abrasion Resistance Evaluation Test

Presence or absence of a scratch was visually confirmed when a steel wool of #0000 was used and reciprocated at 20 times under a load of 200 g. An evaluation criterion was taken as follows.

◯: Completely no scratch observed

◯˜Δ: Fine scratches (not more than 5) observed

Δ: No peeling observed, though scratches were conspicuous

X: Peeled

### Example 1

### (1) Formation of a Hard Coat Layer

### (Preparation of a Composition for Forming a Hard Coat Layer)

A composition for forming a hard coat layer was prepared by mixing the following compounding components:

| | |
|---|---|
| Pentaerythritol triacrylate (PET-30: trade name, | 30.0 parts by mass |
| manufactured by Nippon Kayaku Co., Ltd.) | |
| Irgacure 907 (trade name, manufactured by Chiba | 1.5 parts by mass |
| Specialty Chemicals): | |
| Methyl isobutyl ketone: | 73.5 parts by mass |

### (Formation of a Hard Coat Layer)

The hard coat layer-forming composition prepared above was coated on a 80 μm-thick film of triacetyl cellulose (TAC) with a bar, a solvent was removed by drying, thereafter the coated film was cured through irradiation with ultraviolet rays at an exposure dose of about 20 mJ/cm2 by using a UV irradiator, and thereby a laminate film having a hard coat layer in a film thickness of 10 μm and composed of a laminate film of the substrate/the hard coat layer was obtained.

### (2) Formation of a Low Refractive Index Layer

A composition for forming a low refractive index layer was prepared by mixing the following compounding components.

### (Composition for Forming a Low Refractive Index Layer)

| | |
|---|---|
| A dispersion liquid of hollow silica fine particles | 13.6 parts by mass |
| (hollow silica-methyl isobutyl ketone sol, the | |
| average particle diameter 50 nm and the solid | |
| content 20%, manufactured by Catalysts and | |
| Chemicals Ltd.): | |
| Pentaerythritol triacrylate (PET-30: trade name, | 1.8 parts by mass |
| manufactured by Nippon Kayaku Co., Ltd.) | |
| Irgacure 127 (trade name, manufactured by Chiba | 0.1 part by mass |
| Specialty Chemicals Co., Ltd.): | |
| X-22-164E (trade name, manufactured by Shin-Etsu | 0.2 part by mass |
| Chemical Co., Ltd., silicone with both terminals | |
| modified with methacryl): | |
| 5101X (trade name, manufactured by Solvay Solexis | 0.2 part by mass |
| K.K., a perfluoro polyether compound with both | |
| terminals modified tetra-functional methacrylate): | |
| Methyl isobutyl ketone: | 84.1 parts by mass |

### (3) Preparation of an Optical Functional Film

The low refractive index layer-forming composition prepared above was coated with a bar on the laminate film of the substrate/the hard coat layer obtained in (1), the solvent was removed by drying, and thereafter the coated film was cured through irradiation with ultraviolet rays at an exposure dose of 200 mJ/cm2 by using a UV irradiator (Fusion UV Systems Japan K.K., light source H valve), and thereby a low refractory index layer was formed in a film thickness of about 100 nm.

From the above, an optical functional film having a layer construction of the substrate/the hard coat layer/the low refractive index layer/an antifouling layer (formed by bleeding) was obtained.

### Example 2

An optical functional film having a layer construction of a substrate/a hard coat layer/a low refractive index layer/an antifouling layer (formed by bleeding) was obtained in the same manner as in Example 1, except that a composition for forming the low refractive index layer had the following compounding components.

### (Composition for Forming the Low Refractive Index Layer)

| | |
|---|---|
| A dispersion liquid of hollow silica fine particles | 13.6 parts by mass |
| (hollow silica-methyl isobutyl ketone sol, the | |
| average particle diameter 50 nm and the solid | |
| content 20%, manufactured by Catalysts and | |
| Chemicals Ltd.): | |
| Pentaerythritol triacrylate (PET-30: trade name, | 1.8 parts by mass |
| manufactured by Nippon Kayaku Co., Ltd.): | |
| Irgacure 127 (trade name, manufactured by Chiba | 0.1 part by mass |
| Specialty Chemicals Co., Ltd.): | |
| ZX-007C (the solid content 35%, trade name, | 0.5 part by mass |
| manufactured by Fuji Kasei Kogyo Co., Ltd., | |
| fluorine resin/siloxane graft type polymer): | |
| 5088X (trade name, manufactured by Solvay Solexis | 0.2 part by mass |
| K.K., a perfluoro polyether compound with both | |
| terminals modified with bifunctional urethane | |
| methacrylate): | |
| Methyl isobutyl ketone: | 83.4 parts by mass |

### Example 3

### (1) Formation of a Substrate/a Hard Coat Layer/a Low Refractive Index Layer

A laminate film composed of a substrate/a hard coat layer was obtained in the same manner as in Example 1. Next, a low refractive index layer-forming composition was composed of the following compounding components, and a low refractive index layer was formed on the laminate film.

### (Composition for Forming a Low Refractive Index Layer)

| | |
|---|---|
| A dispersion liquid of hollow silica fine particles | 16.4 parts by mass |
| (hollow silica-methyl isobutyl ketone sol, the | |
| average particle diameter 50 nm, the solid | |
| content 20%, manufactured by Catalysts and | |
| Chemicals Ltd.): | |
| Pentaerythritol triacrylate (PET-30: trade name, | 1.6 parts by mass |
| manufactured by Nippon Kayaku Co., Ltd.): | |
| Irgacure 127 (trade name, manufactured by Chiba | 0.1 part by mass |
| Specialty Chemicals Co., Ltd.): | |
| Methyl isobutyl ketone: | 81.9 parts by mass |

### (2) Formation of an Antifouling Layer

A composition for forming an antifouling layer was prepared by mixing the following compounding components.

### (Composition for Forming an Antifouling Layer)

| | |
|---|---|
| ZX-007C (the solid content 35%, trade name, | 0.6 part by mass |
| manufactured by Fuji Kasei Kogyo Co., Ltd., | |
| fluorine resin/siloxane graft type polymer): | |
| FLUOROLINK D (trade name, manufactured by | 0.1 part by mass |
| Solvay Solexis K.K., a perfluoro polyether compound | |
| with both terminals modified with hydroxyl groups): | |
| CORONATE ® HX (trade name, manufactured | 0.3 part by mass |
| by Nippon Polyurethane Industry Co., Ltd., | |
| isocyanurate type prepolymer): | |
| Isopropyl alcohol: | 9.4 parts by mass |

The antifouling layer forming composition prepared above was coated by bar onto the laminate film of the substrate/the hard coat layer/the low refractive index layer obtained in (1), the solvent was removed by drying, and thereafter the coated film was cured in an oven under the condition of 80° C. and 1 hour, thereby an antifouling layer in a film thickness of about 10 nm was obtained.

From the above, an optical functional film having a layer construction of the substrate/the hard coat layer/the low refractive index layer/an antifouling layer (filmy shape) was obtained.

### Comparative Example 1

An antireflective film was prepared in the same manner as in Example 1, except that a low refractive index layer-forming composition had the following compounding components, and an optical functional film having a layer construction of a substrate/a hard coat layer/a low refractive index layer was obtained.

### (Composition for Forming a Low Refractive Index Layer)

| | |
|---|---|
| A dispersion liquid of hollow silica fine particles | 14.7 parts by mass |
| (hollow silica-methyl isobutyl ketone sol, the | |
| average particle diameter 50 nm and the solid | |
| content 20%, manufactured by Catalysts and | |
| Chemicals Ltd.): | |
| Pentaerythritol triacrylate (PET-30: trade name, | 2.0 parts by mass |
| manufactured by Nippon Kayaku Co., Ltd.): | |
| Irgacure 127 (trade name, manufactured by Chiba | 0.1 part by mass |
| Specialty Chemicals Co., Ltd.): | |
| Methyl isobutyl ketone: | 83.2 parts by mass |

### Comparative Example 2

An antireflective film was prepared in the same manner as in Example 1, except that a low refractive index layer-forming composition had the following compounding components, and an optical functional film having a layer construction of a substrate/a hard coat layer/a low refractive index layer/an antifouling layer (formed by bleeding the silicon-based stain-preventing agent only) was obtained.

### (Composition for Forming a Low Refractive Index Layer)

| | |
|---|---|
| A dispersion liquid of hollow silica fine particles: | 14.0 parts by mass |
| Pentaerythritol triacrylate (PET-30: trade name, | 1.9 parts by mass |
| manufactured by Nippon Kayaku Co., Ltd.): | |
| Irgacure 369 (trade name, manufactured by Chiba | 0.1 parts by mass |
| Specialty Chemicals Co., Ltd.): | |
| X-22-162C (trade name, manufactured by Shin-Etsu | 0.2 part by mass |
| Chemical Industry Co., Ltd., silicone additive with | |
| both terminals modified with carboxyl groups): | |
| Methyl isobutyl ketone: | 83.8 parts by mass |

### Comparative Example 3

An antireflective film was prepared in the same manner as in Example 1, except that a low refractive index layer-forming composition had the following compounding components, and an optical functional film having a layer construction of a substrate/a hard coat layer/a low refractive index layer (formed by bleeding the fluorine based stain-preventing agent only) was obtained.

### (Composition for Forming a Low Refractive Index Layer)

| | |
|---|---|
| A dispersion liquid of hollow silica fine particles: | 14.0 parts by mass |
| Pentaerythritol triacrylate (PET-30: trade name, | 1.9 parts by mass |
| manufactured by Nippon Kayaku Co., Ltd.): | |
| Irgacure 369 (trade name, manufactured by Chiba | 0.1 part by mass |
| Specialty Chemicals Co., Ltd.): | |
| F200 (the solid content 30%, trade name, | 0.8 part by mass |
| manufactured by NOF Corporation, fluorine-based | |
| block copolymer additive): | |
| Methyl isobutyl ketone: | 83.2 parts by mass |

TABLE 1

| | | | | | Comparative | Comparative | Comparative |
|---|---|---|---|---|---|---|---|
| | | Example 1 | Example 2 | Example 3 | Example 1 | Example 2 | Example 3 |
| Minimum Reflectance (%) | | 1.3 | 1.3 | 1.0 | 1.3 | 1.3 | 1.3 |
| Elementary | Si/C | 0.28 | 0.30 | 0.31 | 0 | 0.32 | 0 |
| Ratios | F/C | 0.13 | 0.14 | 0.15 | 0 | 0 | 0.20 |
| Liquid | Contact | 71 | 72 | 74 | 31 | 33 | 68 |
| Paraffin | Angle (°) | | | | | | |
| | Falling | 14 | 14 | 13 | 42 | 38 | 30 |
| | Angle (°) | | | | | | |
| Black | Contact | 40 | 43 | 45 | 28 | 34 | 40 |
| Magic | Angle (°) | | | | | | |
| Marker | Falling | 10 | 11 | 10 | 51 | 28 | 51 |
| | Angle (°) | | | | | | |

| | | | | | | |
|---|---|---|---|---|---|---|
| Dynamic Friction | 0.12 | 0.13 | 0.10 | 0.40 | 0.14 | 0.38 |
| Coefficient (μk) | | | | | | |
| Surface Roughness Ra | 1.1 | 0.9 | 1.1 | 4.5 | 1.9 | 2.2 |
| (nm) | | | | | | |
| Abrasion resistance | ◯ | ◯ | ◯-Δ | Δ | ◯ | Δ |
| (Steel Wool Resistance) | | | | | | |

Measurement of elementary ratios at surfaces of the optical functional films in Examples and Comparative Examples revealed that every Example had the ratio Si/C between the silicon element (Si) and the carbon element (C) of not less than 0.25 and the ratio F/C between the fluorine element (F) and the carbon element (C) of not less than 0.10, and satisfied the following characteristics:

a. the contact angle of the liquid paraffin is not less than 65° and the falling angle of the liquid paraffin is not more than 15°,

b. the contact angle of the black magic marker is not less than 35° and the falling angle of the black magic marker is not more than 15°, and

c. the dynamic friction coefficient is less than 0.15.

To the contrary, Comparative Examples did not satisfy all the above characteristics a to c.

### INDUSTRIAL APPLICABILITY

The provision of the antifouling layer having excellent anti-fingerprint property, anti-magic maker property and slippability at the outmost surface enables the optical functional film to be used at an outermost surface layer in a display of a television, a personal computer, a cell phone or the like, a curved mirror, a back mirror, a goggle, a window glass or other commercial display, and to be favorably used particularly at the outermost surface layer of a display such as a liquid crystal display device.

1-4. (canceled)

5. An optical functional film comprising:
a substrate,
an optical functional layer formed on the substrate, and
an antifouling layer formed on the optical functional layer and having a ratio Si/C between a silicon element (Si) and a carbon element (C) of 0.25 to 1.0, a ratio F/C between a fluorine element (F) and a carbon element (C) of 0.10 to 1.0 at a surface, and the following characteristics:
a. a contact angle of a liquid paraffin is not less than 65° and a falling angle of the liquid paraffin is not more than 15°,
b. a contact angle of a black magic marker is not less than 35° and a falling angle of the black magic marker is not more than 15°, and
c. a dynamic friction coefficient is less than 0.15.

6. The optical functional film according to claim 5, wherein a water contact angle of the antifouling layer is not less than 100°.

7. The optical functional film according to claim 5, wherein a surface roughness (Ra) of the antifouling layer measured by using an atomic force microscope is not more than 2 nm.

8. The optical functional film according to claim 6, wherein a surface roughness (Ra) of the antifouling layer measured by using an atomic force microscope is not more than 2 nm.

9. The optical functional film according to claim 5, wherein the antifouling layer comprises a silicon-containing compound having a siloxane group and a fluorine-containing compound containing at least either a perfluoroalkyl group or a perfluoroalkyl ether group.

10. The optical functional film according to claim 6, wherein the antifouling layer comprises a silicon-containing compound having a siloxane group and a fluorine-containing compound containing at least either a perfluoroalkyl group or a perfluoroalkyl ether group.

11. The optical functional film according to claim 7, wherein the antifouling layer comprises a silicon-containing compound having a siloxane group and a fluorine-containing compound containing at least either a perfluoroalkyl group or a perfluoroalkyl ether group.

12. The optical functional film according to claim 8, wherein the antifouling layer comprises a silicon-containing compound having a siloxane group and a fluorine-containing compound containing at least either a perfluoroalkyl group or a perfluoroalkyl ether group.
